(19) United States
(12) Patent Application Publication
(10) Pub. No.: US 2025/0036344 A1
(43) Pub. Date: Jan. 30, 2025

(54) WEARABLE DISPLAY WITH COUPLED MOBILE INTERFACE MODULE

(71) Applicant: GOOGLE LLC, Mountain View, CA (US)

(72) Inventors: Juha Oikarinen, Los Gatos, CA (US); Jouya Jadidian, Los Gatos, CA (US)

(21) Appl. No.: 18/781,024

(22) Filed: Jul. 23, 2024

Related U.S. Application Data
(60) Provisional application No. 63/528,511, filed on Jul. 24, 2023.

(51) Int. Cl. G06F 3/14; G02B 27/00; G02B 27/01

(52) U.S. Cl. CPC G06F 3/1431; G02B 27/017; G02B 27/0093; G02B 2027/0138; G02B 2027/0178

(57) ABSTRACT

Systems and methods are provided for an augmented reality (AR) display system comprising a wearable display device and a mobile interface module (MIM). The wearable display device includes left and right eye displays communicatively coupled to one or more microcontrollers for processing sensor data and managing display functions. The MIM, distinct from the wearable display device, processes data for the displays and supplies power via an optical tether.

### BACKGROUND

Wearable display devices have become increasingly important for a wide range of applications, including augmented reality (AR), virtual reality (VR), mixed reality (MR), and others. Such devices typically incorporate one or more miniature display screens and associated optics to project visual information into the user's field of view, thereby superimposing digital images onto the physical world or creating a completely virtual environment.

However, several challenges exist with conventional wearable display systems, including a need to balance performance (e.g., display resolution, field of view, and update rate) against device weight and form factor. High-performance display systems often require powerful processors, which can add significant weight and bulk to the device, potentially compromising user comfort and wearability. Moreover, the need to power these processors and displays typically necessitates a battery, which further adds to the weight and size of the device.

Another significant challenge is the delivery of power and data to the wearable display device. Traditional approaches often employ separate cables for power and data, which can be bulky and cumbersome, or wireless technologies, which can suffer from limited battery life, latency issues, and interference.

There is, therefore, a need for improved wearable display systems that can deliver high performance while minimizing weight and maximizing user comfort.

### BRIEF SUMMARY OF SELECTED EMBODIMENTS

The present disclosure may be better understood, and its numerous features and advantages made apparent to those skilled in the art by referencing the accompanying drawings. The use of the same reference symbols in different drawings indicates similar or identical items.

In embodiments, a wearable display system comprises a wearable display device having a left eye display and a right eye display; and a mobile interface module that is distinct from the wearable display device and comprises at least one processor. The mobile interface module may be configured to process data for the left eye display and the right eye display and provide power to the wearable display device.

Each of the left eye display and the right eye display may be communicatively coupled to a respective microcontroller. The mobile interface module and the wearable display device may be configured to be communicatively coupled via a single optical tether. The single optical tether may comprise a first return-path optical connection between the at least one processor and the left eye display, and may comprise a second return-path optical connection between the at least one processor and the right eye display. The first return-path optical connection and the second return-path optical connection may each comprise a vertical-cavity surface-emitting laser (VCSEL) and a transimpedance amplifier (TIA).

The wearable display device may comprise one or more world-facing cameras. The one or more world-facing cameras may include a world-facing camera associated with each of the left eye display and the right eye display.

The wearable display device may comprise one or more eye-tracking cameras. The one or more eye-tracking cameras may include a respective eye-tracking camera associated with each of the left eye display and the right eye display.

The mobile interface module may be configured to couple to an external rendering device from which to receive content for display by the wearable display system. The external rendering device may be a mobile computing device.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIGS. 1 and 2 illustrate an augmented reality (AR) wearable display system, with an eyeglasses form factor coupled to and in communication with a supporting mobile interface module (MIM) via an optical tether, in accordance with some embodiments.

### DETAILED DESCRIPTION

Traditional approaches to wearable display design often encounter significant drawbacks. High-performance components such as processors and batteries contribute to device bulk, reducing wearability and comfort. Data and power delivery to the device are typically handled through separate bulky cables or wireless technologies, which introduce their own complications, such as limited battery life, latency issues, and interference.

Embodiments of techniques described herein utilize a distributed system architecture, such that computational and power-intensive components are offloaded from a wearable heads-up display (WHUD) device to a separate external compute unit, such as a mobile device or a processing puck, referred to herein as a mobile interface module. This approach significantly reduces the weight and complexity of the WHUD device, improving user comfort and wearability. In certain embodiments, optical components such as Vertical-Cavity Surface-Emitting Lasers (VCSELs) and Transimpedance Amplifiers (TIAs) are utilized to provide high-speed, high-efficiency data transfer between the WHUD device and the external compute unit. Power delivery is managed separately in certain embodiments to optimize energy efficiency and device performance.

In various embodiments, a modular design allows for selective attachment of various functional components, such as high-resolution displays, sensors, and power modules, tailored to specific user needs and use cases. This modularity supports configurations for different environments, such as indoor and outdoor settings, and diverse applications, ranging from consumer use to enterprise solutions.

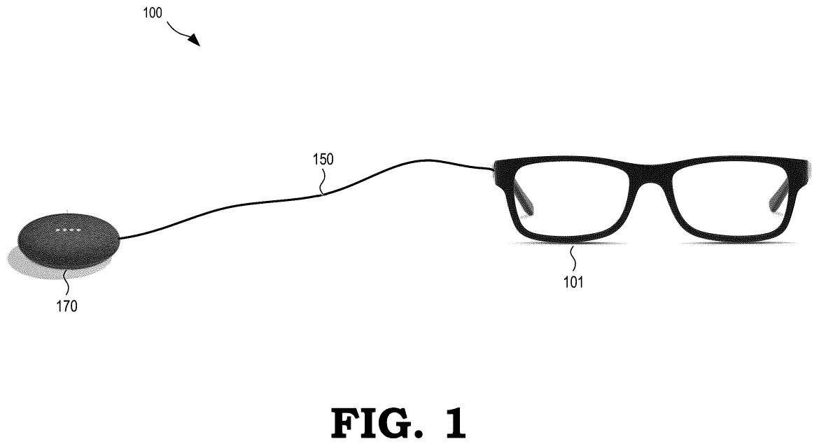

FIG. 1 illustrates a wearable display system 100, which includes a wearable head-up display (WHUD) device 101 and a mobile interface module (MIM) 170 that are interconnected by an optical tether 150. In the depicted embodiment, the optical tether 150 facilitates both power and data transmission between the WHUD device 101 and the MIM 170. As described in greater detail elsewhere herein, the AR display system 100 employs optical and electronic components to deliver a high-performance AR experience while maintaining user comfort and device flexibility. The WHUD device 101 is configured to be worn in proximity to the user's eyes, and generally comprises various components respectively associated with each of the user's eyes.

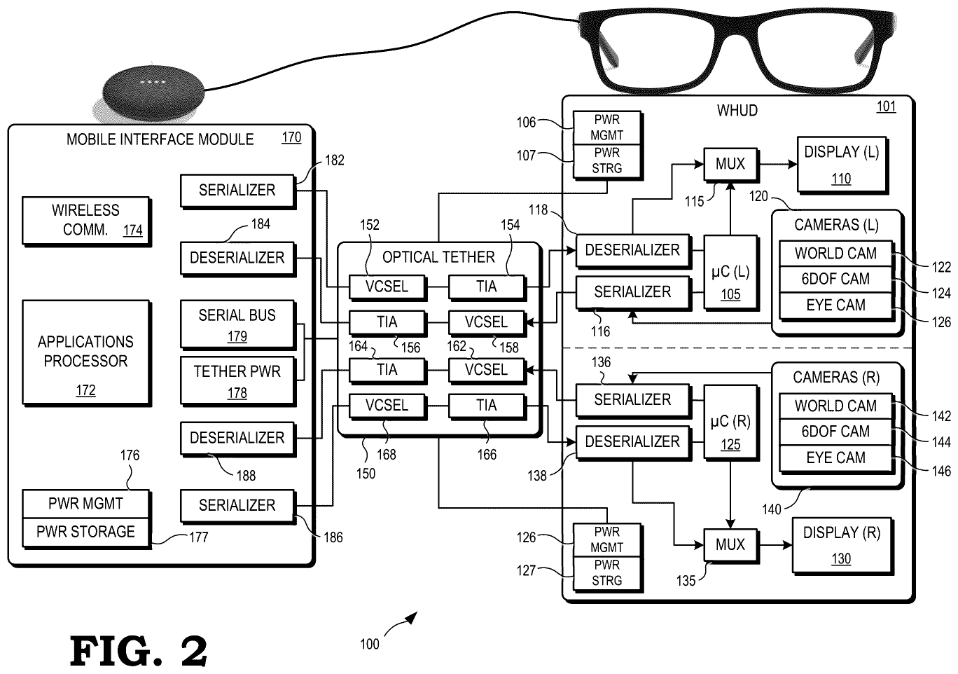

FIG. 2 illustrates additional detail for the depicted embodiment of the wearable display system 100, including the wearable head-up display (WHUD) device 101, optical tether 150, and MIM 170.

Power management 106 and power storage 107 ensure stable and efficient power distribution throughout the WHUD, with rechargeable batteries providing necessary power for the display and sensors. In certain embodiments and scenarios, the power management 106 and power storage 107 are configured to facilitate lightweight and high-capacity power consumption of the WHUD device, supporting prolonged use. For example, in certain embodiments the power storage 107, 127 comprises a small (sub-100 mAh) battery.

Microcontrollers (μC) 105 and 125 manage operations within the WHUD. These microcontrollers process sensor data and manage display functions for each respective eye of the user, and communicate with the MIM 170 through the optical tether 150. The μCs handle real-time processing tasks to ensure a responsive AR experience.

Displays 110 and 130 present AR content to the user, integrated with optical elements for a clear and immersive visual experience. In the depicted embodiment, the displays 110, 130 are each capable of supporting resolutions up to 4K×4K resolution (such as an addressable grid of 4096×4096 pixels) at 90 Hz, providing high-definition visuals with smooth refresh rates for immersive AR applications. In various embodiments and scenarios, optical elements for each display (not separately depicted) may include waveguides and other lens systems to route display light accurately to the user's eyes.

The WHUD device 101 incorporates multiple cameras (collectively and respectively indicated in the depicted embodiment as left-eye cameras 120 and right-eye cameras 140) for various functionalities. World-facing cameras 122 and 142 capture the user's surroundings, enabling environmental interactions and augmented reality overlays. These cameras can provide high-resolution video feeds for contextual awareness. The 6DOF (Six Degrees of Freedom) cameras 124 and 144 track the user's movements in three-dimensional space, providing spatial awareness and improving AR experiences by allowing the system to adjust the display content based on the user's position and orientation. Eye-tracking cameras 126 and 146 monitor the user's eye movements, enabling gaze-based interactions and facilitating accurate alignment of the display content with objects in the user's line of sight.

Multiplexers (MUX) 115 and 135 facilitate the management and routing of signals within the WHUD. These components handle synchronizing inputs from various sensors and outputs to the displays, enabling data to be processed and presented in real-time.

The mobile interface module (MIM) 170 serves as the central processing and power management hub for the AR display system. It includes an applications processor 172 that handles computational tasks, enabling complex AR applications and data processing. The applications processor may be a high-performance multi-core processor optimized for AR workloads. The wireless communication module 174 provides connectivity, allowing the AR system to interface with external devices and networks. In the depicted embodiment, the wireless communication module 174 supports various wireless communication standards, including Wi-Fi and Bluetooth.

A serial bus 179 and tether power management 178 manage data and power transmission for components of the optical tether 150, which comprises a first return-path optical connection between the applications processor 172 and the left eye display 110, and a second return-path optical connection between the applications processor 172 and the right eye display 130. The serial bus facilitates high-speed data transfer between the MIM 170 and the WHUD device 101, while the tether power management ensures efficient power delivery. Power management controller 176 and power storage 177 (e.g., one or more batteries) ensure efficient power distribution and storage within the MIM 170. These components are designed to provide stable power to all parts of the system, optimizing battery life and performance.

In certain embodiments, the mobile interface module 170 comprises external serial bus functionality (such as via the serial bus 179 or other connection) to one or more additional systems and components (not shown). For example, the MIM 170 is configured to couple to an external rendering device (e.g., a mobile computing device sch as a smart phone or other computing device) from which to receive content for display by the wearable display system. In certain embodiments, this functionality enables the MIM 170 to connect to external storage devices for data transfer and backup, ensuring that critical AR data and user settings are preserved. Additionally, in certain embodiments the MIM 170 can interface with external computing systems to offload intensive processing tasks or to update the system's firmware and software. The serial bus connection may also facilitate the integration of supplementary input devices, such as keyboards, mice, or specialized controllers, enhancing the user's ability to interact with the AR environment. Furthermore, such connectivity enables the connection of diagnostic tools and development platforms, such as to aid in the maintenance and upgrading of the AR display system 100. In certain embodiments, the MIM 170 is configured to couple via the serial bus 179 to an external rendering device (not shown) from which to receive content for display by the wearable display system 100.

The MIM 170 also features serializer 182 and deserializer 184 units to convert data formats for transmission through the optical tether 150. In a manner similar to that described elsewhere herein with respect to serializers 116, 136 and deserializers 118, 138, serializer 182 and deserializer 184 ensure that data is transmitted efficiently and accurately between the WHUD device and the MIM 170.

The optical tether 150, connecting the WHUD device 101 and the MIM 170, employs optical components for high-speed data transmission. In the depicted embodiment, VCSELs 152, 158, 166, and 168 are utilized for their efficiency and ability to transmit data at high speeds over optical fibers, and convert electrical data signals into modulated light signals for transmission. Transimpedance amplifiers 154, 156, 162, and 164 convert received optical signals back into electrical signals for processing. TIAs are utilized to maintain signal integrity and to ensure that data is accurately received and processed. This configuration allows for efficient and reliable data transmission between the WHUD device and the MIM 170.

In some embodiments, certain aspects of the systems and techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A wearable display system, comprising:
a wearable display device having a left eye display and a right eye display; and
a mobile interface module that is distinct from the wearable display device and comprises at least one processor;
wherein the at least one processor is configured to process data for the left eye display and the right eye display and provide power to the wearable display device.

2. The wearable display system of claim 1, wherein each of the left eye display and the right eye display are communicatively coupled to a respective microcontroller.

3. The wearable display system of claim 2, wherein the mobile interface module and the wearable display device are configured to be communicatively coupled via a single optical tether.

4. The wearable display system of claim 3, wherein the single optical tether comprises a first return-path optical connection between the at least one processor and the left eye display, and comprises a second return-path optical connection between the at least one processor and the right eye display.

5. The wearable display system of claim 4, wherein the first return-path optical connection and the second return-path optical connection each comprises a vertical-cavity surface-emitting laser (VCSEL) and a transimpedance amplifier (TIA).

6. The wearable display system of claim 1, wherein the wearable display device comprises one or more world-facing cameras.

7. The wearable display system of claim 6, wherein the one or more world-facing cameras includes a world-facing camera associated with each of the left eye display and the right eye display.

8. The wearable display system of claim 1, wherein the wearable display device comprises one or more eye-tracking cameras.

9. The wearable display system of claim 8, wherein the one or more eye-tracking cameras include a respective eye-tracking camera associated with each of the left eye display and the right eye display.

10. The wearable display system of claim 1, wherein the mobile interface module is configured to couple to an external rendering device from which to receive content for display by the wearable display system.

11. The wearable display system of claim 10, wherein the external rendering device is a mobile computing device.
